(19) United States
(12) Patent Application Publication
(10) Pub. No.: US 2019/0068855 A1
(43) Pub. Date: Feb. 28, 2019

(54) ILLUMINATION APPARATUS COMPRISING PLURAL LIGHT EMITTING UNITS, CONTROL METHOD THEREFOR, ILLUMINATION SYSTEM, AND IMAGE PICKUP APPARATUS

(71) Applicant: CANON KABUSHIKI KAISHA, Tokyo (JP)

(72) Inventor: Keiichiro Saito, Tokyo (JP)

(21) Appl. No.: 16/105,419

(22) Filed: Aug. 20, 2018

(30) Foreign Application Priority Data
Aug. 24, 2017 (JP) 2017-161200

(51) Int. Cl. H04N 5/225; H04N 5/235; G06T 7/521; H04N 9/73; G03B 15/05

(52) U.S. Cl. CPC H04N 5/2256; H04N 5/2351; G03B 2215/0596; H04N 9/735; G03B 15/05; G06T 7/521

(57) ABSTRACT

An illumination apparatus which is capable of suppressing a mismatch between color temperature information for each of a plurality of light emitting units that illuminate a subject with light. Whether an optical accessory for toning or adjusting a light distribution angle is attached is detected for each of the plurality of light emitting units. The color temperature information indicative of a color temperature in a light emission when the plurality of light emitting units are caused to emit the light is decided according to light emission information indicative of a light emission state in each of the plurality of light emitting units and a detection result.

### BACKGROUND OF THE INVENTION

### Field of the Invention

The present invention relates to an illumination apparatus, a control method therefor, an illumination system, and an image pickup apparatus, and in particular to an illumination apparatus comprising a plurality of light emitting units.

### Description of the Related Art

In general, an illumination apparatus used together with an image pickup apparatus such as a digital camera sends color temperature information of a light at a time of light emission to the image pickup apparatus, which in turn performs a white balance adjustment based on the color temperature information.

FIG. 10 is a perspective view showing an example of a conventional illumination apparatus.

The illumination apparatus 1000 shown in the figure is a so-called normal illumination apparatus of clip-on type which is detachably attachable to an image pickup apparatus (not shown) and has one light emitting unit 1001. Since the illumination apparatus 1000 has one light emitting unit 1001, the image pickup apparatus decides a white balance based on color temperature information in a light emission from the light emitting unit 1001 at a time of shooting.

On the other hand, in an illumination apparatus comprising a plurality of light emitting units, color temperature information for each of light emitting units may vary. For this reason, when a white balance is decided according to the color temperature information in the image pickup apparatus, a mismatch can occur in white balances decided for each pieces of color temperature information.

In a case where an optical accessory such as an optical filter is attachable to each of the light emitting units, a light emission amount and a light amount which reaches a subject vary with the light emitting units due to presence/absence of the optical accessory and its transmittance. If the color temperature information varies with the light emitting units, there may be a case where the color temperature information cannot be sent from the illumination apparatus to the image pickup apparatus. The similar situation occurs at a time of so called multi-illumination wireless shooting using a plurality of illumination apparatuses.

To avoid this situation, there is an illumination apparatus which adjusts a charging voltage at a time of light emission so that color temperature information of another illumination apparatus becomes equal to color temperature of an illumination apparatus which emits a light with the maximum light emission amount based on the color temperature information of the illumination apparatus which emits the light with the maximum light emission amount (Japanese Laid-Open Patent Publication (Kokai) No. 2011-221363).

However, according to Japanese Laid-Open Patent Publication (Kokai) No. 2011-221363, the illumination apparatus needs to stand by until completion of charging voltage necessary for another illumination apparatus in accordance with the illumination apparatus which emits the light with the maximum light emission amount. For this reason, when shooting is performed with the illumination apparatus, a photographer may miss a shutter chance. In addition, in terms of making the color temperature information for each of illumination apparatuses the same, the charging voltage and the light emission amount for the plurality of illumination apparatus are defined, which makes an adjustment of the light amount difficult.

### SUMMARY OF THE INVENTION

The present invention provides an illumination apparatus which is capable of suppressing a mismatch between color temperature information for each of a plurality of light emitting units, a control method therefor, an illumination system, and an image pickup apparatus.

Accordingly, the present invention provides an illumination apparatus having a plurality of light emitting units that illuminate a subject with light, comprising a processor; and a memory storing a program which, when executed by the processor, causes the illumination apparatus to function as: a detection unit configured to detect whether an optical accessory for toning or adjusting a light distribution angle is attached for each of the plurality of light emitting units; and a decision unit configured to, according to light emission information indicative of a light emission state in each of the plurality of light emitting units and a detection result provided by the detection unit, decide color temperature information indicative of a color temperature in a light emission when the plurality of light emitting units are caused to emit the light.

According to the present invention, the mismatch between the color temperature information for each of the plurality of light emitting units can be suppressed.

Further features of the present invention will become apparent from the following description of exemplary embodiments (with reference to the attached drawings).

### BRIEF DESCRIPTION OF THE DRAWINGS

FIG. 1 is a view showing an arrangement of an example of an image pickup apparatus comprising an illumination apparatus according to a first embodiment of the present invention.

FIG. 2 is a view showing an arrangement of the image pickup apparatus appearing in FIG. 1 with a part of it being raptured.

FIG. 3 is a perspective view showing a relationship between a ring unit and first and second light emitting units appearing in FIG. 2.

FIG. 4 is a flowchart for use in explaining a light emission process of a flash appearing in FIG. 1.

FIG. 5 is a flowchart for use in explaining a color temperature communication control shown in FIG. 4.

FIG. 6 is a view showing an arrangement of an example of a camera comprising a flash according to a second embodiment of the present invention.

FIG. 7 is a view showing an arrangement of an example of a camera comprising a flash according to a third embodiment of the present invention.

FIG. 8 is a view showing an arrangement of an example of a camera comprising a flash according to a fourth embodiment of the present invention.

FIG. 9 is a view showing the camera according to the fourth embodiment of the present invention with other flashes.

FIG. 10 is a perspective view showing an example of a conventional illumination apparatus.

### DESCRIPTION OF THE EMBODIMENTS

Hereinafter, a description will be given of examples of illumination apparatuses according to embodiments of the present invention with reference to the accompanying drawings.

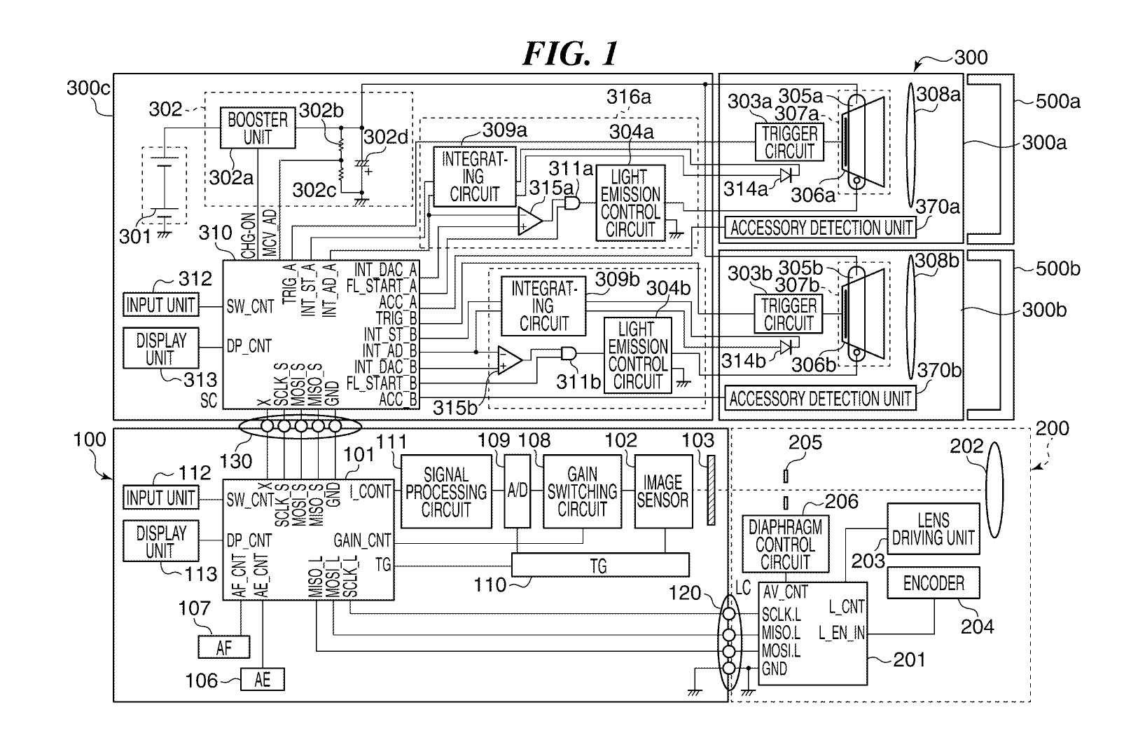

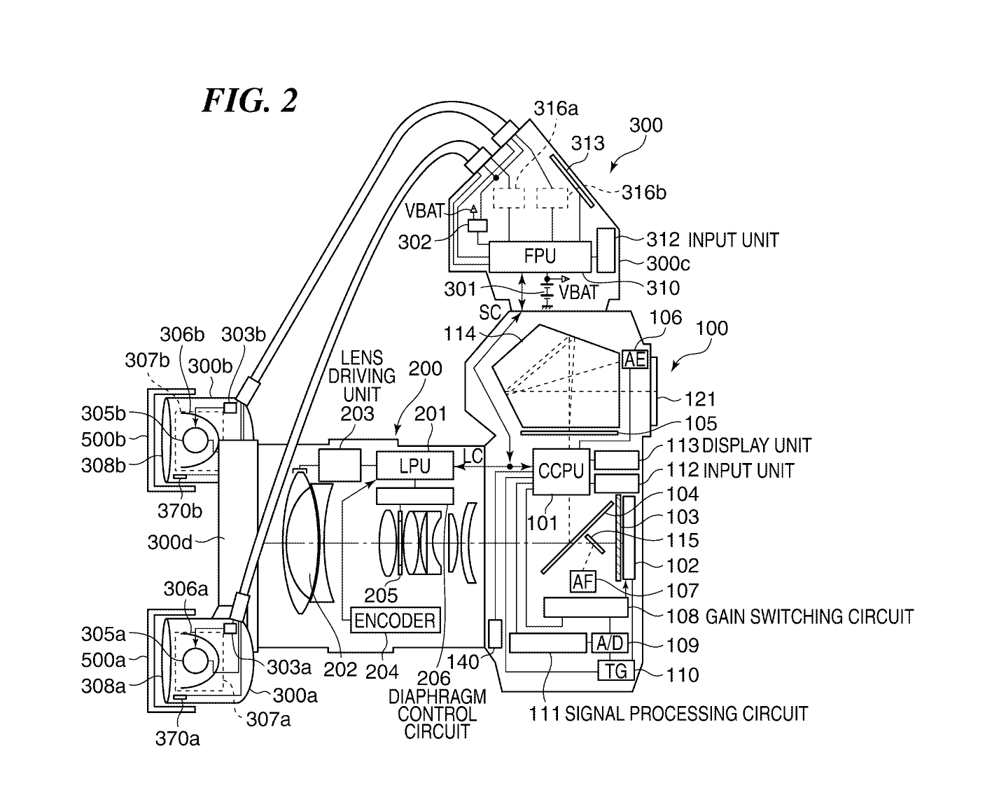

FIG. 1 is a view showing an arrangement of an example of an image pickup apparatus comprising an illumination apparatus according to a first embodiment of the present invention. FIG. 2 is a view showing an arrangement of the image pickup apparatus appearing in FIG. 1 with a part of it being raptured.

Referring to FIGS. 1 and 2, the image pickup apparatus shown in the figure is, for example, a digital camera (hereinafter merely referred to as a camera) having a camera main body 100. An interchangeable shooting lens unit (shooting optical system: hereinafter, merely referred to as a shooting lens) 200 is attached to the camera main body 100. A detachably attachable illumination apparatus (flash apparatus: hereinafter, merely referred to as a flash) 300 is attached to the camera main body 100.

The flash 300 has a first light emitting unit 300a and a second light emitting unit 300b. The first light emitting unit 300a and the second light emitting unit 300b are detachably attached to a ring unit 300d appearing in FIG. 2 which is detachably attached to the shooting lens 200. The first light emitting unit 300a and the second light emitting unit 300b are connected to a main body unit 300c via cables.

It should be noted that an optical accessories 500a and 500b are detachably attached to the first light emitting unit 300a and the second light emitting unit 300b, respectively.

The camera main body 100 has a microcomputer (CCPU: hereinafter, referred to as a camera microcomputer) 101 which controls overall operations of the entire camera. The camera microcomputer 101 is a microcomputer-incorporated one-chip IC circuit. The camera microcomputer 101 has a CPU, a ROM, a RAM, an input output (I/O) control circuit, a multiplexer, a timer circuit, an EEPROM, an A/D converter, a D/A converter, and so on. The camera microcomputer 101 controls the camera main body 100, the shooting lens 200, and the flash 300 according to programs (that is, software) and performs a variety of condition determinations.

An image sensor 102 is a CCD or a CMOS sensor having an infrared cut filter, a low-pass filter, and so on. An optical image (subject image) is formed on the image sensor 102 via a lens group 202, to be described later, and the image sensor 102 outputs an electric signal (analog signal) according to the optical image.

A shutter 103 shields the image sensor 102 from light in a non-shooting state and opens a shutter curtain at the time of shooting to guide the optical image to the image sensor 102. A main mirror (half mirror) 104 selectively moves to a non-shooting position (first position) and a shooting position (second position). At the non-shooting position, the main mirror 104 reflects light incident via the lens group 202 to form an image on a focusing plate 105. The photographer visually checks the image projected on the focusing plate 105 via an eyepiece 121. At the shooting position, the main mirror 104 retracts from an optical path (shooting optical path) of the shooting lens 200.

A photometry circuit (AE) 106 has a photometric sensor. In this embodiment, an image sensor such as a CCD or a CMOS sensor comprising a plurality of pixels is used as the photometric sensor. The photometric sensor is divided into a plurality of areas, and a photometry is performed for each of the areas. It should be noted that a subject image formed on the focusing plate 105 is incident on the photometric sensor via a pentaprism 114.

A focus detection circuit (AF) 107 has a distance measurement sensor which sets a plurality of points as distance measurement points and outputs focus information indicating an amount of defocus for each of the distance measurement points.

A gain switching circuit 108 is a circuit for switching gains which amplifies the electric signal which is the output of the image sensor 102. The gain switching circuit 108 switches gains according to a shooting condition, an instruction from the photographer, and so on under the control of the camera microcomputer 101. An A/D converter 109 converts the electric signal which is the output of the image sensor 102 into a digital signal. A timing generator (TG) 110 synchronizes the electric signal which is the output of the image sensor 102 with timing to perform an A/D conversion by the A/D converter 109.

A signal processing circuit 111 subjects the digital signal which is an output of the A/D converter 109 to image processing according to a predetermined development parameter to generate image data. It should be noted that in this embodiment, a component such as a memory used for processed images is omitted in the figure.

An input unit 112 has an operation section comprising a power switch, a shutter release switch, a setting button and so on, and the camera microcomputer 101 carries out a variety of processes according to an input from the input unit 112. When the shutter release switch is operated for one step (pressed halfway down), a first shutter release switch SW1 is turned on, and the camera microcomputer 101 starts a shooting preparation operation such as a focus adjustment and the photometry. When the shutter release switch is operated for two steps (pressed all the way down), a second shutter release switch SW2 is turned on, and the camera microcomputer 101 starts a shooting operation such as an exposure and a development process. Further, by operating the setting button of the input unit 112, a variety of settings are performed for the flash 300.

A shooting mode set for the camera, other shooting information and so on are displayed on a display unit 113. It should be noted that the display unit 113 has, for example, a liquid crystal display device and a light emitting element.

The pentaprism 114 guides the subject image formed on the focusing plate 105 to the photometric sensor of the photometry circuit 106 and the eyepiece 121. A sub mirror 115 guides a light having passed through the main mirror 104 to the distance measurement sensor of the focus detection circuit 107.

Communication lines LC and SC are interfaces between the camera main body 100 and the shooting lens 200 and the flash 300, respectively. For example, the camera main body 100, the shooting lens 200, and the flash 300 mutually exchange data and transmit commands with the camera microcomputer 101 being a host. For example, as shown in FIG. 1, the communication lines LC and SC have terminals 120 and 130, respectively. The terminals 120 have an SCLK_L terminal, a MOSI_L terminal, a MISO_L terminal, and a GND terminal.

The SCLK_L terminal is a terminal for synchronizing communication between the camera main body 100 and the shooting lens (also referred to as the lens unit) 200. The MOSI_L terminal is a terminal for sending data from the camera main body 100 to the lens unit 200. The MISO_L terminal is a terminal for receiving data sent from the lens unit 200 to the camera main body 100. The camera main body 100 and the lens unit 200 are connected to the GND terminal.

The terminals 130 has an SCLK_S terminal, a MOSI_S terminal, a MISO_S terminal, and a GND terminal. The SCLK_S terminal is a terminal for synchronizing communication between the camera main body 100 and the flash 300. The MOSI_S terminal is a terminal for sending data from the camera main body 100 to the flash 300. The MISO_S terminal is a terminal for receiving data sent from the flash 300 to the camera main body 100. The camera main body 100 and the flash 300 are connected to the GND terminal.

The shooting lens 200 has a microcomputer (LPU: lens microcomputer) 201. The lens microcomputer 201 controls overall operations of the entire shooting lens 200. The lens microcomputer 201 is a microcomputer-incorporated one-chip IC circuit having a CPU, a ROM, a RAM, an input output control circuit, a multiplexer, a timer circuit, an EEPROM, an A/D converter, a D/A converter, and so on.

The shooting lens 200 has the lens group 202 comprising a plurality of lenses which includes at least a focus lens. A lens driving unit 203 moves at least the focus lens in the lens group 202 along an optical axis. The camera microcomputer 101 calculates a driving amount of the lens group 202 based on a detected output of the focus detection circuit 107 and sends the calculated driving amount to the lens microcomputer 201.

An encoder 204 detects a position of the lens group 202 when the lens group 202 is driven. The lens microcomputer 201 controls the lens driving unit 203 according to the driving amount calculated by the camera microcomputer 101. The lens microcomputer 201 refers to a position indicated by an output of the encoder 204 and drivingly controls the lens group 202 to perform a focus adjustment. A diaphragm control circuit 206 controls a diaphragm 205 under the control of the lens microcomputer 201.

The flash 300 has the main body unit 300c detachably attached to the camera main body 100. As described earlier, The first light emitting unit 300a and the second light emitting unit 300b are connected to the main body unit 300c via the cables. The first light emitting unit 300a and the second light emitting unit 300b are detachably attached to the ring unit 300d. The ring unit 300d is detachably attached to a front end of the shooting lens 200, and the light is emitted from the front end of the shooting lens 200.

It should be noted that the first light emitting unit 300a and the second light emitting unit 300b are respectively held in a rotatable manner in a vertical direction and a horizontal direction. In the following description, a state where the first light emitting unit 300a and the second light emitting unit 300b are attached to a left side and a right side of the ring unit 300d, respectively, is assumed as a normal position. A description will be given of a rotational direction of the first light emitting unit 300a and the second light emitting unit 300b assuming that a main body unit 300c side of the first light emitting unit 300a and the second light emitting unit 300b as an upper side.

The flash 300 has a microcomputer (FPU: flash microcomputer) 310 which controls overall operation of the entire flash 300. The flash microcomputer 310 is a microcomputer-incorporated one-chip IC circuit having a CPU, a ROM, a RAM, an input output control circuit, a multiplexer, a timer circuit, an EEPROM, an A/D converter, a D/A converter, and so on.

A battery 301 is a power source (VBAT) for the flash 300, and a booster circuit 302 has a booster unit 302a, resistances 302b and 302c used for detecting a voltage, and a main capacitor 302d. The booster circuit 302 causes the booster unit 302a to boost a voltage of the battery 301 to several hundred V to accumulate an electric energy for light emission in the main capacitor 302d. A charging voltage of the main capacitor 302d is divided by the resistances 302b and 302c, and the divided voltages are input to the A/D converter of the flash microcomputer 310.

The flash 300 has a first light emitting unit control circuit 316a and a second light emitting unit control circuit 316b. The first light emitting unit control circuit 316a and the second light emitting unit control circuit 316b control light emission from the first light emitting unit 300a and the second light emitting unit 300b, respectively.

In the first light emitting unit 300a, a discharge tube 305a is excited by an energy charged in the main capacitor 302d by receiving a pulse voltage of several KVs applied from a trigger circuit 303a and emits a light. The light from the discharge tube 305a is irradiated to the subject and the like.

A photodiode 314a receives the light from the discharge tube 305a and outputs a detected output (current) according to its light emission amount. The photodiode 314a receives the light from the discharge tube 305a directly or via a grass fiber and an ND filter.

In the first light emitting unit control circuit 316a, an integrating circuit 309a integrates a current which is an output of the photodiode 314a. An output (integration output) of the integrating circuit 309a is input to an inverting input terminal of the comparator 315a and an A/D converter terminal (INT_AD_A) of the flash microcomputer 310.

A non-inverting input terminal of a comparator 315a is connected to a D/A converter output terminal (INT_DAC_A) of the flash microcomputer 310, and an output terminal of the comparator 315a is connected to one of input terminals of an AND gate 311a. The other of the input terminals of the AND gate 311a is connected to a light emission control terminal (FL_START_A) of the flash microcomputer 310, and an output terminal of the AND gate 311a is connected to a first light emission control circuit 304a. The first light emission control circuit 304a controls start and stop of light emission from the discharge tube 305a.

In the first light emitting unit 300a, the trigger circuit 303a is connected to a trigger terminal (TRIG_A) of the flash microcomputer 310 and controlled by the flash microcomputer 310.

Similarly, in the second light emitting unit 300b, a trigger circuit 303b is connected to a trigger terminal (TRIG_B) of the flash microcomputer 310 and controlled by the flash microcomputer 310. A discharge tube 305b is excited by an energy charged in the main capacitor 302d by receiving a pulse voltage of several KVs applied from the trigger circuit 303b and emits a light. The light from the discharge tube 305b is irradiated to the subject and the like.

A photodiode 314b receives the light from the discharge tube 305b and outputs a detected output (current) according to its amount of emission. The photodiode 314b receives the light from the discharge tube 305b directly or via a grass fiber and an ND filter.

In the second light emitting unit control circuit 316b, an integrating circuit 309b integrates a current which is an output of the photodiode 314b. An integration output of the integrating circuit 309b is input to an inverting input terminal of the comparator 315b and an A/D converter terminal (INT_AD_B) of the flash microcomputer 310.

A non-inverting input terminal of a comparator 315b is connected to a D/A converter output terminal (INT_DAC_B) of the flash microcomputer 310, and an output terminal of the comparator 315b is connected to one of input terminals of an AND gate 311b. The other of the input terminals of the AND gate 311b is connected to a light emission control terminal (FL_START_B) of the flash microcomputer 310, and an output terminal of the AND gate 311b is connected to a second light emission control circuit 304b. The second light emission control circuit 304b controls start and stop of light emission from the discharge tube 305b.

The first light emitting unit 300a is provided with a reflector unit 307a which has the above described discharge tube 305a and a reflector 306a. An optical system having an optical panel 308a and the like is held by the reflector unit 307a.

The reflector 306a reflects and guides the light emitted from the discharge tube 305a in a predetermined direction. The optical system changes an irradiation angle of the light emitted from the first light emitting unit 300a. It should be noted that an irradiation range can be varied by changing a relative position between the reflector unit 307a and the optical panel 308a.

An accessory detection unit 370a is, for example, a switch for detecting whether an optical accessory 500a for toning or light distribution angle adjustment is attached. The accessory detection unit 370a sends ON-OFF information (detection result) indicative of whether the optical accessory 500a is attached to the flash microcomputer 310. It should be noted that a plurality of optical accessories can be attached at the same time, and the accessory detection unit corresponds in number to the optical accessory is provided. The accessory detection unit is not limited to a switch, but may be a known sensor.

The optical accessory 500a is, for example, a color filter, a bounce adapter, or a diffuser, and attached on an optical panel surface of the first light emitting unit 300a. The optical accessory 500a performs toning, diffusion, or change of a light distribution angle of the flash light to improve a lighting effect at the time of shooting. The optical accessory 500a is provided with a protrusion at a location facing the accessory detection unit 370a, and attachment of the optical accessory 500a is detected by the protrusion pushing the accessory detection unit 370a.

Similarly, the second light emitting unit 300b is provided with a reflector unit 307b which has the above described discharge tube 305b and a reflector 306b. An optical system having an optical panel 308b and the like is held by the reflector unit 307b. The second light emitting unit 300b is also provided with an accessory detection unit 370b which detects whether an optical accessory 500b is attached.

It should be noted that the light distribution angle of the first light emitting unit 300a and the second light emitting unit 300b varies with movement of the reflector unit 307a and 307b, respectively. The light irradiation direction of the first light emitting unit 300a and the second light emitting unit 300b varies with their rotating motion with respect to the ring unit 300d. Namely, the first light emitting unit 300a and the second light emitting unit 300b are rotatable vertically and horizontally with respect to the ring unit 300d.

The input unit 312 has an operating unit comprising a power switch, a mode setting switch for setting an operation mode of the flash 300, and a setting button for setting a variety of parameters. The flash microcomputer 310 carries out a variety of processes according to an input from the input unit 312. Information indicative of a status of the flash 300 is displayed on the display unit 313. It should be noted that the display unit 313 is provided with a liquid crystal device and a light emitting element.

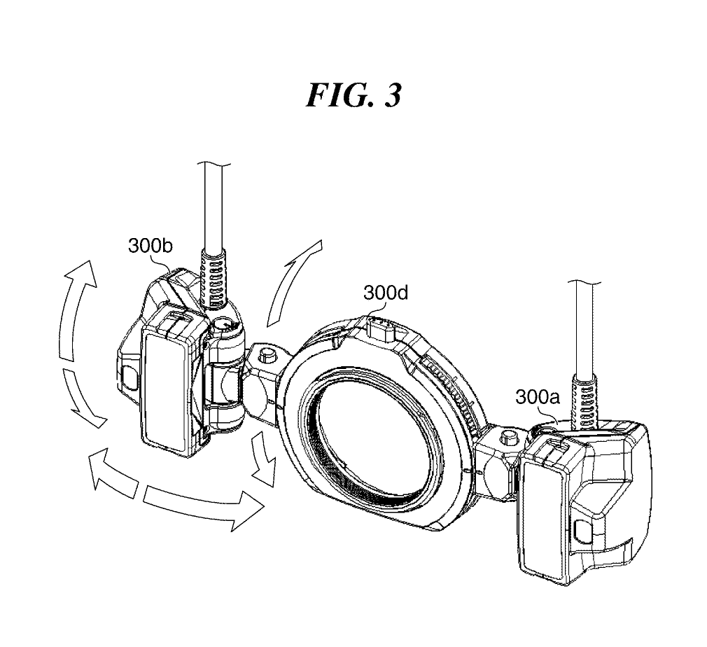

FIG. 3 is a perspective view showing a relationship between the ring portion 300d and the first light emitting unit 300a and the second light emitting unit 300b appearing in FIG. 2.

The above described ring unit 300d is attached to the lens unit 200 by hooking a claw (nor shown) to a projection formed on the lens unit 200. Bases to which the first light emitting unit 300a and the second light emitting unit 300b are respectively attached are formed in symmetrical locations in the ring unit 300d. The bases are rotatable in a circumferential direction. Accordingly, as shown in the figure, the first light emitting unit 300a and the second light emitting unit 300b are rotatable vertically and horizontally with respect to the ring unit 300d.

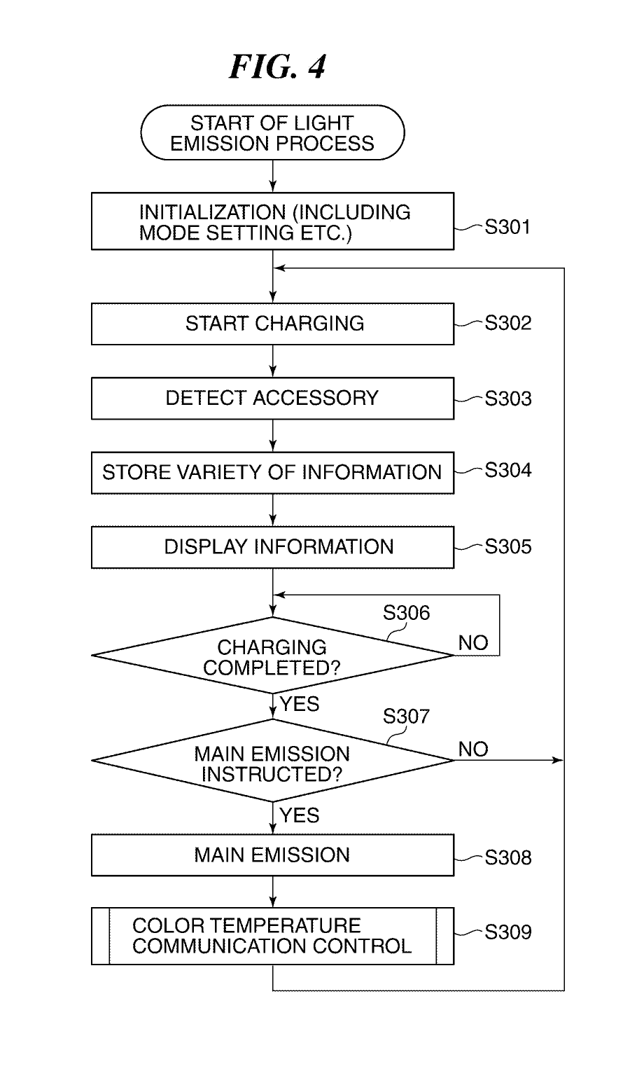

FIG. 4 is a flowchart for use in explaining a light emission process by the flash 300 appearing in FIG. 1.

When the power switch of the input unit 312 is turned on to make the flash microcomputer 310 operable, the flash microcomputer 310 starts the process of the flowchart in FIG. 4.

At first, the flash microcomputer 310 initializes a memory and a port provided in the flash microcomputer 310 (step S301). At this time, the flash microcomputer 310 reads a state of a switch provided in the input unit 312 and input information set in advance to configure setting on a light emitting mode such as a determination method of a light emission amount and a light emitting timing.

Subsequently, the flash microcomputer 310 controls the booster circuit 302 to start charging the main capacitor 302d (step S302). After staring charging of the main capacitor 302d, the flash microcomputer 310 stores accessory detection information detected by the accessory detection unit 370a and 370b in a built-in memory (step S303). It should be noted that in a case where the accessory detection information has already been stored, the flash microcomputer 310 updates the accessory detection information.

The flash microcomputer 310 stores a variety of information such as other settings and detection results in the built-in memory (step S304). The variety of information includes information of the camera main body 100 and the lens unit 200, if necessary, other than information of the flash 300. For example, the flash microcomputer 310 stores focal length information obtained from the camera microcomputer 101 via the communication line SC as one of the variety of information in the built-in memory. It should be noted that in a case where the focal length information has already been stored, the flash microcomputer 310 updates the focal length information.

Subsequently, the flash microcomputer 310 displays a light emitting mode set by the input unit 312 and the variety of information on the display unit 313 (step S305). The flash microcomputer 310 then determines whether charging of the main capacitor 302d has been completed (step S306). Upon determining that the charging of the main capacitor 302d has not been completed (NO in step S306), the flash microcomputer 310 stands by. On the other hand, upon determining that the charging of the main capacitor 302d has been completed (YES in step S306), the flash microcomputer 310 sends a charge completion signal to the camera microcomputer 101 and proceeds the process to step S307.

The flash microcomputer 310 determines whether a light emission starting signal which is a main emission instruction is received from the camera microcomputer 101 (step S307). Upon determining that the light emission starting signal is not received (NO in step S307), the flash microcomputer 310 returns the process to step S302.

On the other hand, upon determining that the light emission starting signal is received (YES in step S307), the flash microcomputer 310 controls the first light emission control circuit 304a and the second light emission control circuit 304b according to the light emission starting signal to emit the light from the discharge tubes 305a and 305b (step S308). After completing the main emission, the flash microcomputer 310 stores information regarding the light emission such as a voltage of the main capacitor 302d in the built-in memory and proceeds the process to step S309.

It should be noted that in a case where a sequence of light emissions comprised of a pre-emission for light control and a main emission is performed in step S308, the flash microcomputer 310 proceeds the process to step S309 after completing the sequence of light emissions.

The flash microcomputer 310 decides color temperature information to be used for the white balance adjustment of an image obtained by shooting based on information regarding light emission, to be described later. The flash microcomputer 310 performs a color temperature communication control in which it sends the color temperature information to the camera microcomputer 101 via the communication line SC (step S309). The flash microcomputer 310 then returns to the process in step S302.

It should be noted that the color temperature information includes information for deciding a white balance in an image obtained by the shooting.

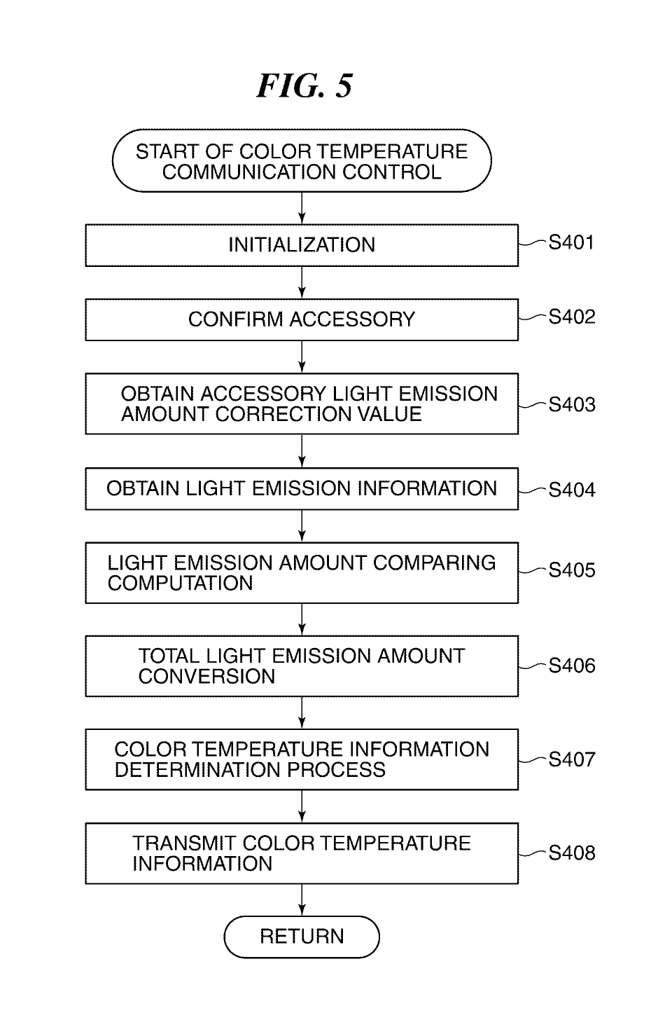

FIG. 5 is a flowchart for use in explaining the color temperature communication control appearing in FIG. 4. It should be noted that in the following description, the color temperature information refers to a set (pair) of information comprised of a color temperature value and a color deviation value, however, tristimulus values or color temperatures defined in various color systems, or wave length information may be used as the color temperature information.

When the flash 300 performs main emission in step S308 explained by referring to FIG. 4, the flash microcomputer 310 starts the color temperature communication control shown in the figure.

At first, the flash microcomputer 310 initializes a setting regarding the color temperature communication control (step S401). It should be noted that in a case where the setting regarding the color temperature communication control was initialized in step S301 explained by referring to FIG. 4, the process in step S401 may be omitted.

The flash microcomputer 310 then reads accessory detection information stored in the built-in memory in step S303 in FIG. 3. The flash microcomputer 310 confirms whether at least one of the optical accessories 500a and 500b is attached to the flash 300 at the time of light emission (step S402). At this time, the flash microcomputer 310 also confirms a type of the attached optical accessories 500a and 500b.

It should be noted that when the optical accessories 500a and 500b are not attached to the flash 300, the process in step S402 may be omitted. The flash microcomputer 310 then stores information on the optical accessories 500a and 500b in the built-in memory.

Subsequently, the flash microcomputer 310 reads a light emission amount correction value when the optical accessory is attached, which is stored in advance in the built-in memory from the built-in memory based on the confirmed information on the optical accessories 500a and 500b (step S403). The light emission amount correction value is used for correcting increase and decrease in a light amount of a light generated when the optical accessory is attached.

It should be noted that when the optical accessory 500a and 500b are not attached to the flash 300, the process in step S403 may be omitted. The flash microcomputer 310 then stores the light emission amount correction value in the built-in memory when the optical accessory 500a and 500b are attached to the flash 300.

Subsequently, the flash microcomputer 310 obtains light emission information indicative of a light emission state of the first light emitting unit 300a and the second light emitting unit 300b (step S404). The light emission information includes information such as a light emission amounts of the light emitting units, the charging voltage of the main capacitor 302d at the time of light emission, a light emitting method indicating whether a light emission is either of flashing or flat light emission. The light emission amounts of the light emitting units are calculated, for example, based on the integrated outputs of the integrating circuits 309a and 309b or the light emission instruction by the flash microcomputer 310.

Alternatively, in a case where a plurality of main capacitors 302d is provided correspondingly in number to the light emitting units, the light emission amount in each of the light emitting units may be calculated according to the voltage of the main capacitor 302d. Moreover, in a case where the pre-emission is performed, a result obtained by the photometry circuit 106 measuring the light emission amount of pre-emission for light control may be used. In this case, the pre-emissions in the light emitting units are performed in different timing, and the photometry is performed by the photometry circuit 106. Storing results of the photometry in the pre-emissions by the light emitting units in the built-in memory prior to the main emission prevents increase in the number of pre-emissions prior to the main emission. The flash microcomputer 310 stores the light emission information of the light emitting units in the built-in memory.

The flash microcomputer 310 then performs a light emission amount comparing computation based on the information obtained in steps S402 to S404 (step S405). Here, the flash microcomputer 310 obtains ratios of lights which reach the subject to the lights emitted from the light emitting units and compares the ratios. Namely, the light emission amount comparing computation is performed in light not only of a light amount ratio between the discharge tube 305a and 305b but also of an attenuation caused by a difference in a transmittance between the optical system including the optical panel 308a and the optical accessories 500a and 500b.

For example, it is assumed that the light emission is performed by flashing and with a light amount ratio in which the light emission instruction value of the second light emitting unit 300b is set −1 EV lower than that of the first light emitting unit 300a. Here, it is also assumed that the optical accessory 500a is detected, and the optical accessory 500a is a diffuser which lowers the light amount by 2 EV. It is further assumed that the flash microcomputer 310 has read the light emission amount correction value corresponding to −2 EV in step S403.

In this case, assuming that the first light emitting unit 300a and the second light emitting unit 300b have the same optical system, a computation result of the first light emitting unit 300a to which the optical accessory 500a is attached is lower by 1 EV than that of the second light emitting unit 300b is obtained as a difference of lights which reach the subject.

In a case where the results of the photometry in the pre-emission ware also obtained in addition to perform the light emission amount comparing computation based on the light emission instruction value and the transmittance, the results of the photometry corresponds to the lights that have passed through the optical accessories, and thus the results of photometry may be compared. Further, whether to use the light emission instruction value or to use the results of the photometry in the pre-emissions may be switched according to whether a light emission ratio control setting (ratio setting) is configured for the light emitting units in step S304.

As described above, after performing the light emission amount comparing computation, the flash microcomputer 310 stores, in the built-in memory, information (maximum light emitting unit information) on the light emitting unit of which ratio of the light amount which reaches the subject is the largest. It should be noted that in a case where the color temperature information is obtained by weighted average in order to obtain an optimum white balance, the process in step S405 may be omitted.

Subsequently, the flash microcomputer 310 calculates a total amount of light emission (total light emission amount) based on the light emission information for each of the light emitting units (step S406: total light emission amount conversion). The flash microcomputer 310 then stores the total light emission amount in the built-in memory.

The flash microcomputer 310 decides the color temperature information based on the information obtained in steps S402 to S406 (step S407). The flash microcomputer then stores the color temperature information in the built-in memory.

The built-in memory of the flash microcomputer 310 stores a color temperature information table. In the color temperature information table, the color temperature information is recorded (defined) correspondingly to the total light emission amount and the charging voltage of the main capacitor 302d for each of presence or absence of the optical accessories 500a and 500b and the light emitting method.

For example, in an example described with reference to the above described step S405, the ratio of the light amount which reaches the subject of the second light emitting unit 300b is greater than that of the first light emitting unit 300a. Accordingly, the flash microcomputer 310 decides the color temperature information based on the information on the second light emitting unit 300b. In the example described above, the second light emitting unit 300b performs flashing, and the optical accessory 500b is not attached to the second light emitting unit 300b. Therefore, the flash microcomputer 310 refers to the color temperature information table which indicates that the light emitting method is flashing and the optical accessory is not attached.

In a case where a light emission amount of the first light emitting unit 300a is 1/1 light emission and a light emission amount of the second light emitting unit 300b is 1/2 light emission, the total light emission amount corresponds to 3/4 light emission. Accordingly, when the charging voltage of the main capacitor 302d at the time of light emission is 300V, the flash microcomputer 310 obtains color temperature information (color temperature value and color deviation value) corresponding to 3/4 emission and 330V by referring to the color temperature information table. In this case, currents flowing in the discharge tubes 305a and 305b are different between a case where one light emitting unit is caused to emit a light and a case where a plurality of light emitting units are caused to emit a light. Therefore, since the color temperature value and the color temperature deviation value are also different at the time of light emission, the color temperature information is decided by using the total light emission amount obtained in step S406.

A correlation is established between the currents flowing in the discharge tubes 305a and 305b and the light emission amount, and thus the currents flowing in the discharge tubes 305a and 305b can be used as a guideline for determining the color temperature information. Moreover, it is assumed that in a case where a resolution is roughened by, for example, compressing the color temperature table, the discharge tubes 305a and 305b are caused to emit a light with a light emission amount and a charging voltage which are intermediate values in the color temperature information table. In this case, it is desirable to use, as the color temperature information, an average value of the color temperature information immediately smaller and greater than the intermediate light emission amount and the intermediate charging voltage.

It should be noted that when the light emission amount comparing computation is omitted, the color temperature information is decided by using the weighted average. When the color temperature information is decided by using the weighted average, the flash microcomputer 310 obtains the color temperature information based on the color temperature information table for each of the light emitting units. The flash microcomputer 310 then decides the color temperature information by subjecting color temperature information to the weighted average according to the light emission amount or the result of photometry in the pre-emission of each of the light emitting units.

Subsequently, the flash microcomputer 310 sends the color temperature information stored in the built-in memory to the camera microcomputer 101 via the communication line SC (step S408). The flash microcomputer 310 then terminates the color temperature communication control.

It should be noted that upon receiving the color temperature information, the camera microcomputer 101 stores the color temperature information in the built-in memory. The camera microcomputer 101 performs the white balance adjustment with the color temperature information on an image obtained by shooting according to the setting of the camera main body 100. The camera microcomputer 101 also adds predetermined information to image data obtained by subjecting the image to the white balance adjustment. The camera microcomputer 101 then stores the image data in a recording medium (not shown) and terminates a sequence of shooting process.

As described above, in the first embodiment of the present invention, the color temperature information to be used for the white balance adjustment is decided according to the ratio of the light emitting amount for each of the light emitting units. Consequently, mismatch of the color temperature information between the light emitting units is suppressed, and an optimum white balance adjustment is performed.

Next, a description will be given of an example of a camera comprising a flash according to a second embodiment of the present invention.

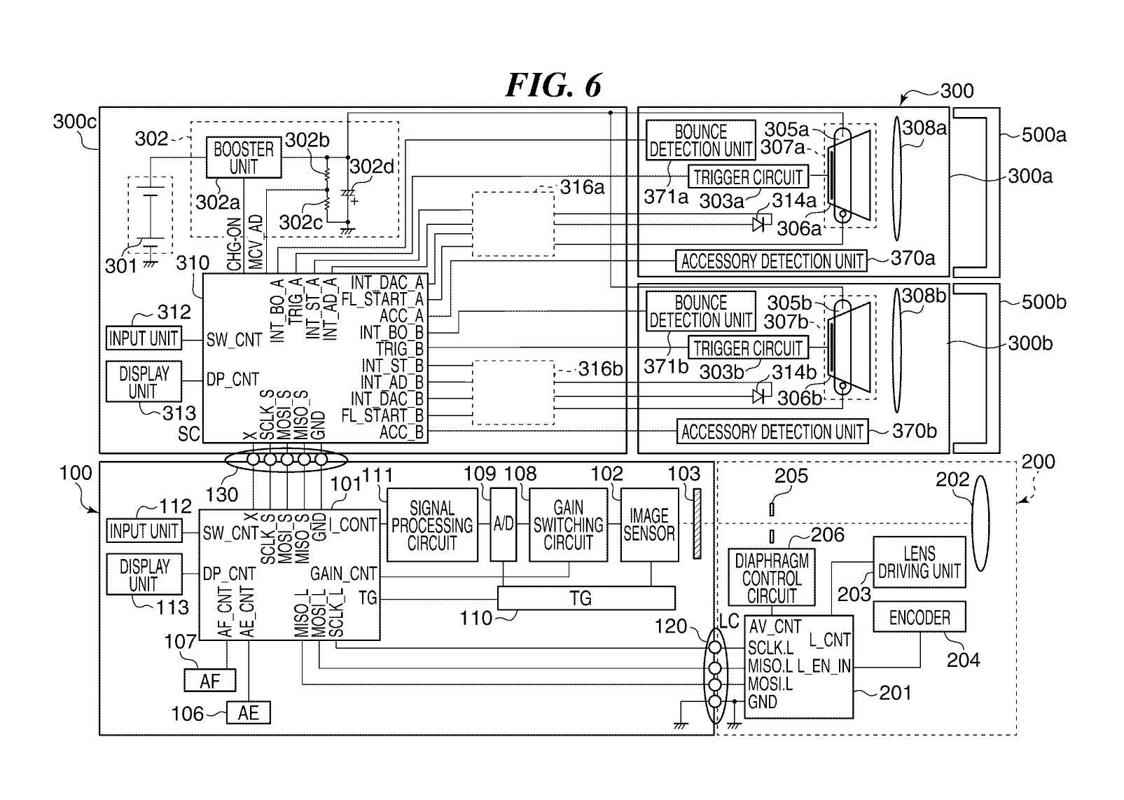

FIG. 6 is a view showing an arrangement of the camera comprising the flash according to the second embodiment of the present invention. It should be noted that in FIG. 6, the same reference numerals are assigned to the same component elements as that of the camera in FIG. 1, and explanations thereof are omitted.

As shown in the figure, the first light emitting unit 300a and the second light emitting unit 300b have a first bounce detection unit 371a and a second bounce detection unit 371b, respectively. The first bounce detection unit 371a and the second bounce detection unit 371b each detects whether an irradiation direction of the first light emitting unit 300a or the second light emitting unit 300b has changed from a predetermined normal position. That is, the first bounce detection unit 371a and the second bounce detection unit 371b each detects whether the light emitting unit 300a or the second light emitting unit 300b is in a bounce state.

It should be noted that a switch-type sensor which exclusively detects presence or absence of the bounce state is used as the first bounce detection unit 371a and the second bounce detection unit 371b. Moreover, an angle detection sensor such as an encoder or a potentiometer which detects an angle of the irradiation direction (namely, a bounce angle) may be used as the first bounce detection unit 371a and the second bounce detection unit 371b.

A description will be given of a light emission process performed by the flash according to the second embodiment of the present invention with reference to FIG. 4. Here, only a description will be given of a process different from the light emission process performed by the flash according to the first embodiment.

In step S304, the flash microcomputer 310 stores, in the built-in memory, bounce detection results detected by the first bounce detection unit 371a and the second bounce detection unit 371b in the built-in memory as one of variety of information. It should be noted that in a case where the bounce detection units are switch-type sensors, the flash microcomputer 310 records bits indicative of whether the first light emitting unit 300a and the second light emitting unit 300b are in the bounce state. On the other hand, in a case where the bounce detection units are the angle detection sensors, the flash microcomputer 310 stores the bounce angles in the built-in memory or updates the bounce angles stored in the built-in memory.

Subsequently, a description will be given of a color temperature communication control performed by the flash according to the second embodiment of the present invention. Here, only a description will be given of a process different from the color temperature communication control performed by the flash according to the first embodiment.

In step S404, the flash microcomputer 310 obtains the bounce detection results when the light emission information on the light emitting units. The flash microcomputer 310 then stores the bounce detection results as well as the light emission information in the built-in memory.

In step S405, the flash microcomputer 310 performs a light emission amount comparing computation based on the variety of information obtained in steps S402 to S404, as described earlier. At this time, the flash microcomputer 310 performs the light emission amount comparing computation in light of the bounce detection results.

For example, the first bounce detection unit 371a and the second bounce detection unit 371b are assumed to be the switch-type sensors. In this case, if the first light emitting unit 300a and the second light emitting unit 300b are in the bounce state, the light which reaches the subject from each of the light emitting units attenuates. Accordingly, the flash microcomputer 310 performs the light emission amount comparing computation by attenuating the light emission amount of the light emitted from the light emitting units in the bounce state by several EVs.

In a case where the first bounce detection unit 371a and the second bounce detection unit 371b are the angle detection sensors, the flash microcomputer 310 obtains an amount of attenuation of the light emission amount based on the cosine fourth low according to the bounce angle. After performing the light emission amount comparing computation, the flash microcomputer 310 stores, in the built-in memory, information on the light emitting unit of which ratio of the light amount which reaches the subject is the largest.

It should be noted that as with the case of the first embodiment, the process in step S405 may be omitted when the color temperature information is obtained by the weighted average. In this case, the flash microcomputer 310 obtains the color temperature information by referring to the color temperature information table for each of the light emitting units in step S407. The flash microcomputer 310 then subjects the color temperature information to the weighted average according to the light emission amounts of the light emitting units and the bounce detection results of the light emission units to decide the color temperature information.

Therefore, in the second embodiment of the present invention, since the color temperature information is decided in light of the bounce detection results, the color temperature information is decided with high accuracy according to whether the light emitting unit is in the bounce state.

Subsequently, a description will be given of an example of a camera comprising a flash according to a third embodiment of the present invention.

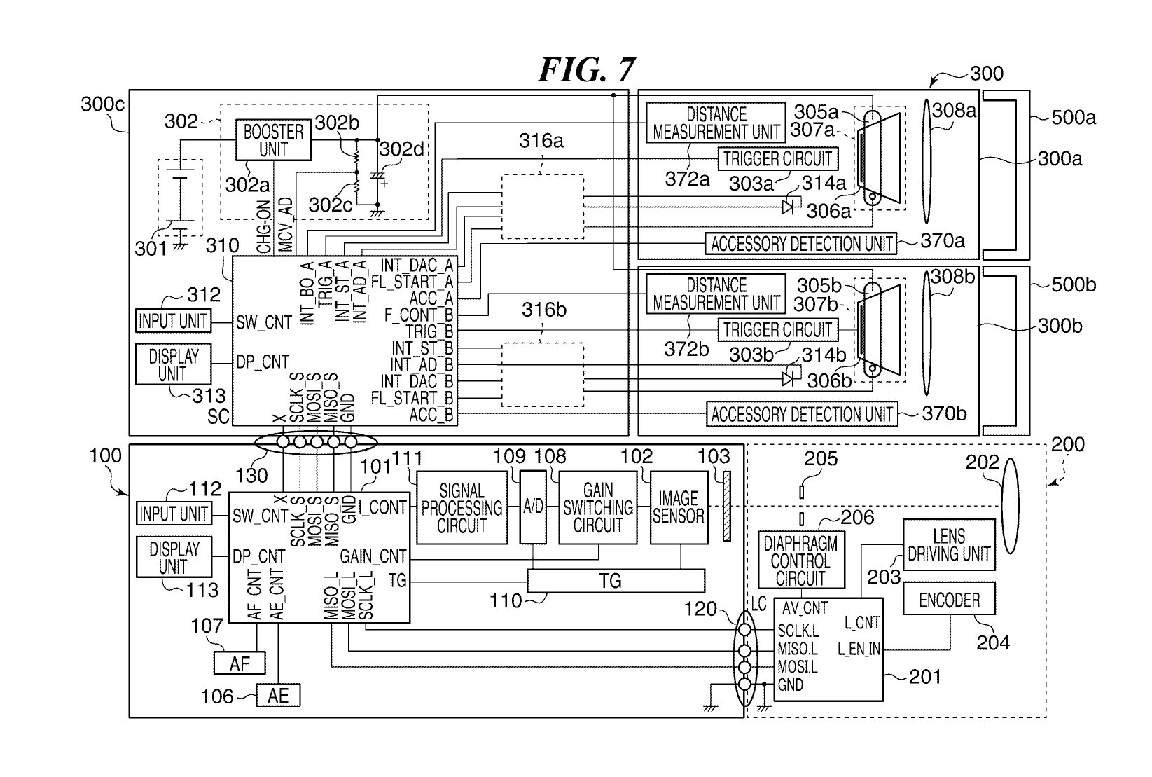

FIG. 7 is a view showing an arrangement of the example of the camera comprising the flash according to the third embodiment of the present invention. It should be noted that in FIG. 7, the same reference numerals are assigned to the same component elements as that of the camera in FIG. 1, and explanations thereof are omitted.

As shown in the figure, the first light emitting unit 300a and the second light emitting unit 300b have a first distance measurement unit 372a and a second distance measurement unit 372b, respectively. The first distance measurement unit 372a and the second distance measurement unit 372b measure a distance from the first light emitting unit 300a to the subject and a distance from the second light emitting unit 300b to the subject, respectively. In the example shown in the figure, the first distance measurement unit 372a and the second distance measurement unit 372b each detects a light amount of a reflected light (reflected light amount) reflected from the subject through a reflected light detection. The flash microcomputer 310 then obtains a distance to the subject according to the reflected light amount.

A description will be given of a light emission process performed by the flash according to the third embodiment of the present invention. Here, only a description will be given of a process different from the light emission process performed by the flash according to the first embodiment.

In step S308, the flash microcomputer 310 causes the light from the discharge tubes 305a and 305b to emit the light by the light emitting control circuits 304a and 304b according to a light emission starting signal. The first distance measurement unit 372a and the second distance measurement unit 372b receive a reflected light generated in the pre-emission for light control performed at the time of light emission and send a reflected light amount to the flash microcomputer 310. The flash microcomputer 310 obtains distances from the first light emitting unit 300a and the second light emitting unit 300b to the subject based on the reflected light amounts.

In step S301, a distance to the subject may be obtained by performing the pre-emission in the same manner even in a case where a light emission mode in which the light control is not needed like a manual light emission. Moreover, in a case where the distance measurement is performed through the pre-emission, the distance measurement is performed in different timing for each of the light emission units. After completing the pre-emission, the flash microcomputer 310 stores the distance to the subject as a subject distance in the built-in memory.

It should be noted that in a case where a sequence of light emissions comprised of the pre-emission and the main emission is performed in step S308, the flash microcomputer 310 proceeds the process to step S309 after completing the sequence of light emissions.

Next, a description will be given of a color temperature communication control performed by the flash according to the third embodiment of the present invention. Here, only a description will be given of a process different from the light emission process performed by the flash according to the first embodiment.

In step S404, the flash microcomputer 310 obtains a subject distance as described above when the light emission information on the light emitting units. The flash microcomputer 310 then stores the subject distance as well as the light emission information in the built-in memory.

In step S405, the flash microcomputer 310 performs the light emission amount comparing computation based on the variety of information obtained in steps S402 to S404 as described earlier. At this time, the flash microcomputer 310 performs the light emission amount comparing computation in light of the subject distance.

For example, it is assumed that a distance between the subject and the first light emitting unit 300a is Xa, and a distance between the subject and the second light emitting unit 300b is Xb. In this case, a light amount ratio (reflected light amount ratio) Yba of the second light emitting unit 300b to the first light emitting unit 300a is expressed by a square-low of the distance by the following equation (1).

$$\begin{matrix}[ Mathematical expression 1 ] & \\ Yba = {( \frac{Xa}{Xb} )}^{2} & ( 1 )\end{matrix}$$

The flash microcomputer 310 multiplies the light amount ratio Yba by the light amount of the second light emitting unit 300b and compares the obtained result with the light amount of the first light emitting unit 300a. It should be noted that the flash microcomputer 310 may obtain a light amount ratio Yab of the first light emitting unit 300a to the second light emitting unit 300b, multiply the light amount of the first light emitting unit 300a by the light amount ratio Yab to compare the obtained result with the light amount of the second light emitting unit 300b. The flash microcomputer 310 may perform comparison according to a guide number-based ratio of a distance.

After performing the light amount comparing computation, the flash microcomputer 310 stores, in the built-in memory, information on the light emitting unit of which ratio of a light amount which reaches the subject is the largest.

It should be noted that as with the case of the first embodiment, the process in step S405 may be omitted when the color temperature information is obtained by the weighted average. In this case, the flash microcomputer 310 obtains the color temperature information by referring to the color temperature information table for each of the light emitting units in step S407. The flash microcomputer 310 then subjects the color temperature information to the weighted average according to the light emission amounts of the light emitting units and the subject distance for each of the light emitting units to decide the color temperature information.

Therefore, in the third embodiment of the present invention, since the color temperature information is decided in light of the subject distance for each of the light emitting units, the color temperature information is decided with high accuracy according to the distance between the light emitting unit and the subject.

Subsequently, a description will be given of an example of a camera comprising a flash according to a fourth embodiment of the present invention.

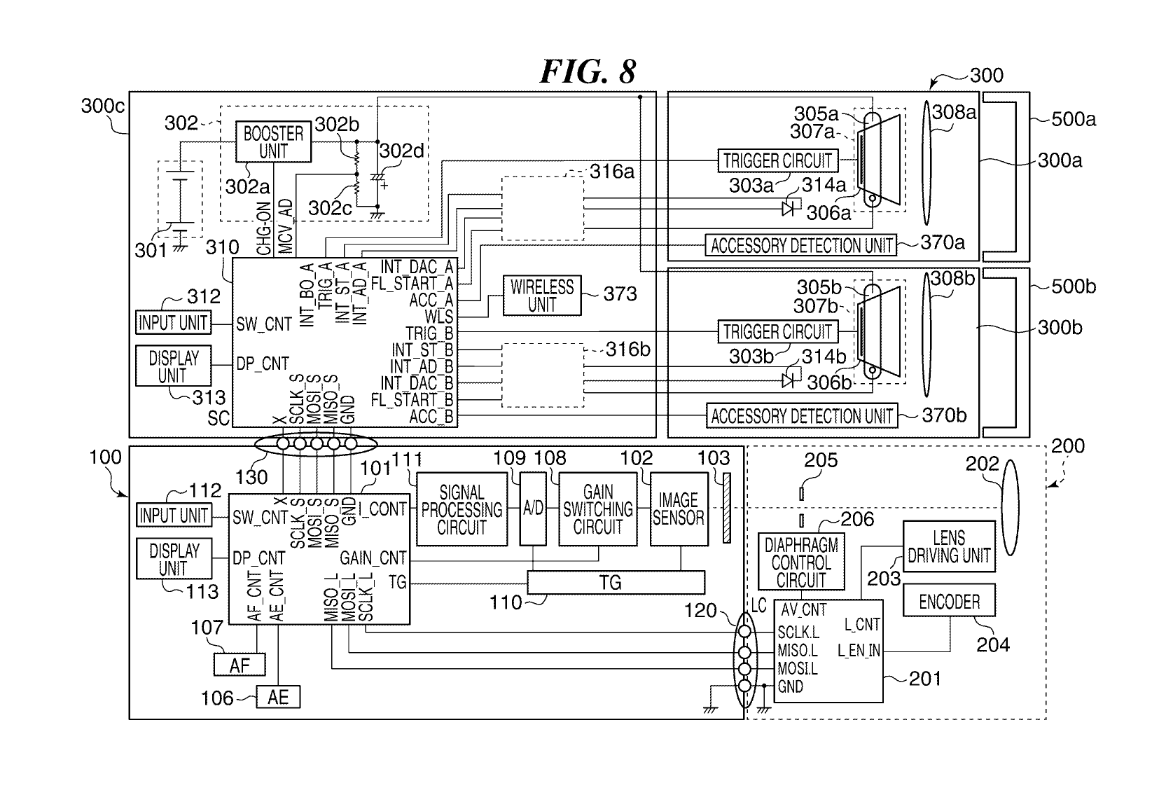

FIG. 8 is a view showing an arrangement of the example of the camera comprising the flash according to the fourth embodiment of the present invention. It should be noted that in FIG. 8, the same reference numerals are assigned to the same component elements as that of the camera in FIG. 1, and explanations thereof are omitted.

As shown in the figure, the main body unit 300c is provided with a wireless unit 373. The flash microcomputer 310 performs wireless communication by the wireless unit 373, as to be described later.

In this embodiment, the flash microcomputer 310 performs wireless bi-directional communication with other flashes provided with a wireless unit by the wireless unit 373. By setting an ID and a channel by using the input unit 312, the user is capable of performing the wireless communication with other flashes to which the same settings are configured. The settings for the wireless communication are configured by the input unit 112 via the communication line SC.

It should be noted that although in the example shown in the figure, the wireless communication is assumed to be performed through a radio wave, the wireless communication may be performed through optical communication if a wireless light-receiving unit is provided.

A description will be given of a light emission process performed by the flash according to the fourth embodiment of the present invention. Here, only a description will be given of a process different from the light emission process performed by the flash according to the first embodiment.

In step S304, the flash microcomputer 310 stores, in the built-in memory, the ID, the channel and so on set by the input unit 312 as communication setting information, which is one of the variety of information. The flash microcomputer 310 then searches another flash to which the same communication setting information is configured based on the communication setting information. Upon the another is found, the flash microcomputer 310 stars the wireless communication with the another flash. After the wireless communication is established, the flash microcomputer 310 stores bits indicative of the flash is in a wireless communication state in the built-in memory.

In step S308, the flash microcomputer 310 causes the discharge tubes 305a and 305b to perform the pre-emission by the light emission control circuits 304a and 304b according to the light emission starting signal. At this time, the pre-emission for light control is performed for each of the light emitting units, and the photometry circuit 106 performs the photometry. The flash microcomputer 310 stores the result of photometry in the built-in memory.

It should be noted that in step S308, in a case where the sequence of light emissions comprised of the pre-emission and the main emission is performed in step S308, the flash microcomputer 310 proceeds the process to step S309 after completing the sequence of light emissions.

Next, a description will be given of a color temperature communication control performed by the flash according to the fourth embodiment of the present invention. Here, only a description will be given of a process different from the color temperature communication control performed by the flash according to the first embodiment.

In step S404, the flash microcomputer 310 obtains the result of photometry by the photometric circuit 106 when the light emission information on the light emitting units is obtained. The flash microcomputer 310 stores the result of photometry as well as the light emission information in the built-in memory.

It should be noted that the flash microcomputer 310 obtains the result of photometry in the pre-emission (including the result of photometry by the another flash) from the camera microcomputer 101 via the communication line SC. The flash microcomputer 310 also causes the wireless unit 373 to obtain the light emission information from the another flash which are in the wireless communication.

In step S405, the flash microcomputer 310 performs the light emission amount comparing computation based on the variety of information obtained in steps S402 to S404 as described earlier.

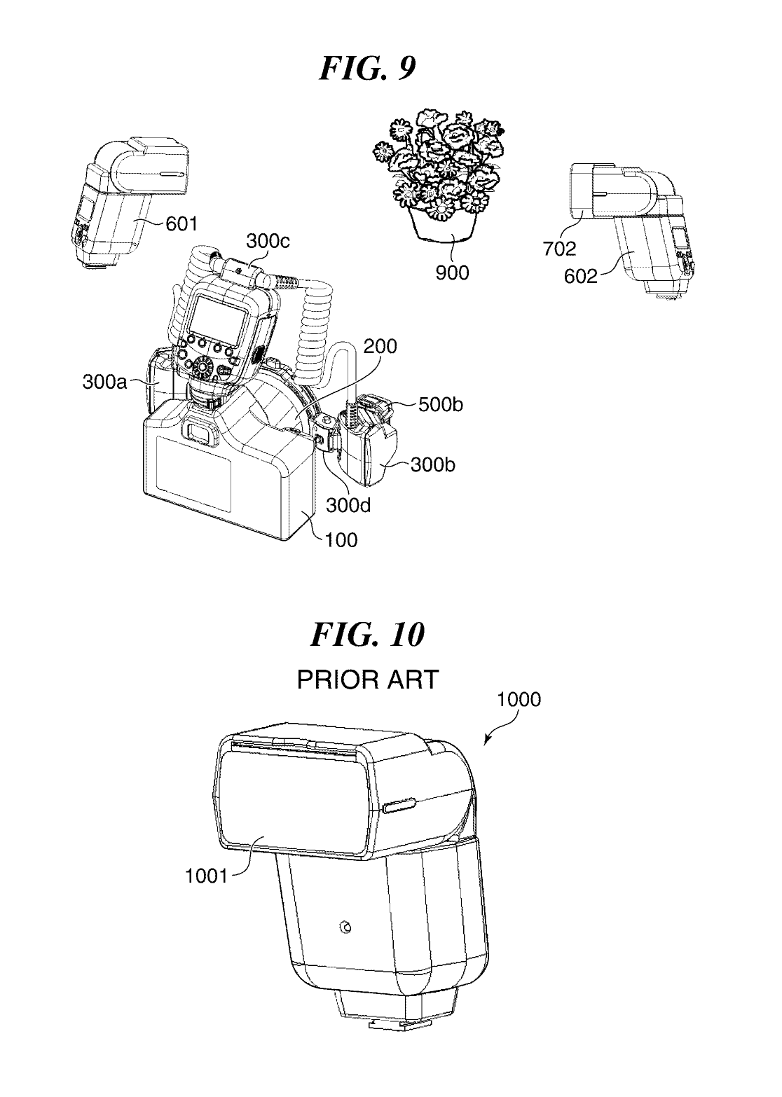

FIG. 9 is a view showing the camera according to the fourth embodiment of the present invention as well as other flashes.

In FIG. 9, an example in which the camera having the flash 300 (main illumination device) shoots a subject 900 by using the other flashes 601 and 602, that is, an example of a so called wireless multiple lamp shooting is shown. The other flashes 601 and 602 and the flash 300 constitute an illumination system.

In this embodiment, the flash 300 of the camera main body 100 is provided with the first light emitting unit 300a and the second light emitting unit 300b. The flash 300 is assumed to perform the wireless bi-directional communication with the flash 601 and 602 both of which have a wireless unit.

The flashes 601 and 602 are of a so called clip-on type and have one light emitting unit, respectively. The light emitting unit 300b and the light emitting unit of the flash 602 is provided with the optical accessory 500b and 702, respectively. The optical accessory 500b and 702 are, for example, diffusers.

It should be noted that it is assumed that the flashes 300, 601, and 602 are set so that they can illuminate the subject 900 with light.

In this embodiment, the light emitting units of the flashes 300 and 601, and 602 are grouped: the first light emitting unit 300a is placed in a group A; the second light emitting unit 300b is placed in a group B; the light emitting unit of the flash 601 is placed in a group C; and the light emitting unit of the flash 602 is placed in a group D.

Assuming that the results of photometry in the pre-emission obtained in step S308 described earlier are C>A>B>D. In this case, the result of photometry of the Group C (namely, the light emission amount in the pre-emission) is the largest, and thus the flash microcomputer 310 decides to use the light emission information on the flash 601 for the process in step S407.

It should be noted that, similar to the first embodiment, in a case where the light emission amount comparing computation is performed based on a light amount ratio and an attenuation caused by a transmittance of and the optical accessories, and so on, the flash microcomputer 310 obtains attenuation information on the optical accessory 702 from the flash 602.

In the example shown in FIG. 8, although the flash 300 is connected to the camera main body 100, the flash 601 or the flash 602 may be connected to the camera main body 100. Moreover, the process may be carried out similarly even in a case where the wireless multiple lamp shooting is performed by only using a flash having only one light emitting unit without using a flash having a plurality of light emitting unit like the flash 300.

After performing the light emission amount comparing computation, the flash microcomputer 310 stores, in the built-in memory, the light emission information on the light emitting unit of which ratio of the light amount which reaches the subject is the largest.

It should be noted that as with the case of the first embodiment, the process in step S405 may be omitted when the color temperature information is obtained by the weighted average. In this case, the flash microcomputer 310 obtains the color temperature information by referring to the color temperature information table for the respective light emitting units in step S407. The flash microcomputer 310 then subjects the color temperature information to the weighted average according to the light emission amounts of the light emitting units and the result of the photometry for each of the light emitting units to decide the color temperature information.

Therefore, in the fourth embodiment of the present invention, the color temperature information is decided with high accuracy when the wireless multiple lamp shooting is performed as well.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-161200, filed Aug. 24, 2017, which is hereby incorporated by reference herein in its entirety.

What is claimed is:

1. An illumination apparatus having a plurality of light emitting units that illuminate a subject with light, comprising:
a processor; and
a memory storing a program which, when executed by the processor, causes the illumination apparatus to function as:
a detection unit configured to detect whether an optical accessory for toning or adjusting a light distribution angle is attached for each of the plurality of light emitting units; and
a decision unit configured to, according to light emission information indicative of a light emission state in each of the plurality of light emitting units and a detection result provided by the detection unit, decide color temperature information indicative of a color temperature in a light emission when the plurality of light emitting units are caused to emit the light.

2. The illumination apparatus according to claim 1,
wherein the light emission information includes at least a light emission amount in each of the plurality of light emitting units,
the illumination apparatus is caused to further function as a storage unit configured to store a table which defines the color temperature information according to the light emission amount and the detection result provided by the detection unit for each of the plurality of light emitting units, and
the decision unit decides the color temperature information by referring to the table.

3. The illumination apparatus according to claim 2, wherein the decision unit sets one of tables stored in the storage unit as a table for reference according to a light amount ratio indicative of a ratio of the light emission amounts in the plurality of light emitting units.

4. The illumination apparatus according to claim 3, wherein the decision unit decides the color temperature information by referring the table for reference based on a total light emission amount obtained according to the light emission amount in each of the plurality of light emitting units and the detection result provided by the detection unit.

5. The illumination apparatus according to claim 2, wherein the decision unit obtains the color temperature information by referring to the table for each of the plurality of light emitting unit and decides color temperature information by subjecting the color temperature information of the plurality of light emitting units to weighted average based on the light emission amounts in the plurality of light emitting units.

6. The illumination apparatus according to claim 2, the illumination apparatus is caused to further function as a second detection unit configured to detect an illumination direction of the light for each of the plurality of light emitting units,
wherein the decision unit corrects for the light emission amount in each of the plurality of light emitting units according to a detection result provided by the second detection unit.

7. The illumination apparatus according to claim 3, the illumination apparatus is caused to further function as a distance measurement unit configured measure a distance from each of the plurality of light emitting units to the subject,
wherein the decision unit obtains the light amount ratio according to the distance obtained by the distance measurement unit.

8. The illumination apparatus according to claim 3,
wherein an image pickup apparatus to be used together with the illumination apparatus comprises a distance measurement unit that measures a distance from each of the plurality of light emitting units to the subject, and
the decision unit obtains the light amount ratio according to the distances obtained by the distance measurement unit.

9. The illumination apparatus according to claim 7, wherein the distance measurement unit receives a reflected light from the subject in a light emission for each of the plurality of light emitting units to obtain the distance according to a light-emission timing and a light-receiving timing.

10. An image pickup apparatus that receives color temperature information from an illumination apparatus having a plurality of light emitting units which illuminate a subject with light, the image pickup apparatus comprising:
a processor; and
a memory storing a program which, when executed by the processor, causes the illumination apparatus to function as:
an image processing unit configured to correct for an image obtained by pickup according to the color temperature information,
wherein the illumination apparatus comprises:
a detection unit configured to detect whether an optical accessory for toning or adjusting a light distribution angle is attached for each of the plurality of light emitting units; and
a decision unit configured to, according to light emission information indicative of a light emission state in each of the plurality of light emitting units and a detection result provided by the detection unit, decide color temperature information indicative of a color temperature in a light emission when the plurality of light emitting units are caused to emit the light.

11. An illumination system that has a plurality of illumination apparatus and illuminates a subject with light by using the plurality of illumination apparatus,
wherein one of the plurality of illumination apparatuses is set as a main illumination apparatus,
each of the plurality of illumination apparatuses has a detection unit which detects whether an optical accessory for toning or adjusting a light distribution angle is attached,
the other illumination apparatuses other than the main illumination apparatus has a sending unit which sends light emission information indicative of a light emission state and a detection result provided by the detection unit to the main illumination apparatus, and
the main illumination apparatus has a receiving unit which receives, from the other illumination apparatuses, the light emission information and the detection result provided by the detection unit, and a decision unit which decides color temperature information indicative of a color temperature in a light emission when the plurality of illumination apparatuses emit the light according to light emission information in the main illumination apparatus, light emission information in the other illumination apparatuses, and the detection result provided by the detection unit.

12. An image pickup apparatus that receives color temperature information from a main illumination apparatus, comprising:
a processor; and
a memory storing a program which, when executed by the processor, causes the illumination apparatus to function as:
an image processing unit configured to correct for an image obtained by pickup according to the color temperature information,
wherein the main illumination apparatus is one of a plurality of illumination apparatuses included in an illumination system which illuminate a subject with light by using the plurality of illumination apparatuses,
each of the plurality of illumination apparatuses has a detection unit which detects whether an optical accessory for toning or adjusting a light distribution angle is attached,
each of the other illumination apparatuses other than the main illumination apparatus has a sending unit which sends light emission information indicative of a light emission state and a detection result provided by the detection unit to the main illumination apparatus, and
the main illumination apparatus has a receiving unit which receives, from the other illumination apparatuses, the light emission information and the detection result provided by the detection unit, and a decision unit which decides color temperature information indicative of a color temperature in a light emission when the plurality of illumination apparatuses emit the light according to light emission information in the main illumination apparatus, light emission information in the other illumination apparatuses, and the detection result provided by the detection unit.

13. A control method for an illumination apparatus having a plurality of light emitting units that illuminate a subject with light, the control method comprising:
a detection step of detecting whether an optical accessory for toning or adjusting a light distribution angle is attached for each of the plurality of light emitting units; and
a decision step of deciding, according to light emission information indicative of a light emission state in each of the plurality of light emitting units and a detection result in the detection step, color temperature information indicative of a color temperature in a light emission when the plurality of light emitting units are caused to emit the light.
